(19) United States
(12) Patent Application Publication
(10) Pub. No.: US 2024/0412084 A1
(43) Pub. Date: Dec. 12, 2024

(54) OUT-OF-DISTRIBUTION DETECTION FOR PERSONALIZING NEURAL NETWORK MODELS

(71) Applicant: QUALCOMM Incorporated, San Diego, CA (US)

(72) Inventor: Haijun ZHAO, Beijing (CN)

(21) Appl. No.: 18/262,717

(22) PCT Filed: Mar. 12, 2021
(86) PCT No.: PCT/CN2021/080415

§ 371 Date: Jul. 24, 2023

(51) Int. Cl. G06N 5/04; G06F 9/50; G06N 3/045

(52) U.S. Cl. CPC G06N 5/04; G06F 9/5011; G06N 3/045

(57) ABSTRACT

A method for generating a personalized artificial neural network (ANN) model receives an input at a first artificial neural network. The input is processed to extract a set of intermediate features. The method determines if the input is out-of-distribution relative to a dataset used to train the first artificial neural network. The intermediate features corresponding to the input are provided to a second artificial neural network bases on the out-of-distribution determination. Additionally, the system resources for performing the training and inference tasks of the first artificial neural network and the second, personalized artificial neural network are allocated according to a computational complexity of the training and inference tasks and a power consumption of the resources.

### BACKGROUND

### Field

Aspects of the present disclosure generally relate to neural networks, and more particularly, on-device detection of out-of-distribution data for personalizing a neural network model.

### Background

Artificial neural networks may comprise interconnected groups of artificial neurons (e.g., neuron models). The artificial neural network may be a computational device or represented as a method to be performed by a computational device.

Neural networks consist of operands that consume tensors and produce tensors. Neural networks can be used to solve complex problems, however, because the network size and the number of computations that may be performed to produce the solution may be voluminous, the time for the network to complete a task may be long. Furthermore, because these tasks may be performed on mobile devices, which may have limited computational power, the computational costs of deep neural networks may be problematic.

Convolutional neural networks are a type of feed-forward artificial neural network. Convolutional neural networks may include collections of neurons that each have a receptive field and that collectively tile an input space. Convolutional neural networks (CNNs) such as deep convolutional neural networks (DCNs) have numerous applications. In particular, these neural network architectures are used in various technologies, such as image recognition, pattern recognition, speech recognition, autonomous driving, and other classification tasks.

Machine learning performance may be lower than reported as research results. This may be due to variations in training as well as device hardware and their operating environment characteristics, for example. Detecting test samples drawn sufficiently distant from a training distribution statistically is a fundamental requirement for deploying many real-world machine learning applications.

Unfortunately, on-device learning is also difficult. One aim of incremental learning is for the learning model to adapt to new data without forgetting its existing knowledge (training). However, specific user data on-device (e.g., user-dependent) may be small relative to the training distribution or dataset and may result in poor performance.

### SUMMARY

In an aspect of the present disclosure, a method for generating a personalized artificial neural network (ANN) model is provided. The method includes receiving an input at a first artificial neural network. The method includes processing the input to extract a set of intermediate features. The method also includes determining if the input is out-of-distribution relative to a dataset for training the first artificial neural network. Additionally, the method includes providing the intermediate features corresponding to the input to a second artificial neural network based at least in part on the out-of-distribution determination.

In another aspect of the present disclosure, an apparatus for generating a personalized artificial neural network (ANN) model is provided. The apparatus includes a memory and one or more processors coupled to the memory. The processor(s) are configured to receive an input at a first artificial neural network. The processor(s) are configured processing the input to extract a set of intermediate features. The processor(s) are also configured to determine if the input is out-of-distribution relative to a dataset for training the first artificial neural network. In addition, the processor(s) are configured to provide the intermediate features corresponding to the input to a second artificial neural network based at least in part on the out-of-distribution determination.

In an aspect of the present disclosure, an apparatus for generating a personalized artificial neural network (ANN) model is provided. The apparatus includes means for receiving an input at a first artificial neural network. The apparatus includes means for processing the input to extract a set of intermediate features. The apparatus also includes means for determining if the input is out-of-distribution relative to a dataset for training the first artificial neural network. Additionally, the apparatus includes means for providing the intermediate features corresponding to the input to a second artificial neural network based at least in part on the out-of-distribution determination.

In a further aspect of the present disclosure, a non-transitory computer readable medium is provided. The computer readable medium has encoded thereon program code for generating a personalized artificial neural network (ANN) model. The program code is executed by a processor and includes code to receive an input at a first artificial neural network. The program code includes code to process the input to extract a set of intermediate features. The program code also includes code to determine if the input is out-of-distribution relative to a dataset for training the first artificial neural network. Additionally, the program code includes code to provide the intermediate features corresponding to the input to a second artificial neural network based at least in part on the out-of-distribution determination.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SoC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions.

FIG. 5 is a block diagram illustrating an example architecture for energy efficient personalizing of an artificial neural network model, in accordance with aspects of the present disclosure.

FIG. 6 is a block diagram illustrating offline distilling of knowledge to produce a distilled user-independent classifier for operating on a mobile device, in accordance with aspects of the present disclosure.

FIG. 7 is a block diagram illustrating an example of offline search and optimization of a user-dependent classifier (UDC) and user-independent out of distribution (UIOOD) detector, in accordance with aspects of the present disclosure.

FIG. 8 is a block diagram illustrating an example operation of the gating agent, in accordance with aspects of the present disclosure.

FIG. 9 is a block diagram illustrating an example of cooperative incremental learning on device, in accordance with aspects of the present disclosure.

FIG. 10 illustrates a method for operating an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Neural networks can be used to solve complex problems, however, because the network size and the number of computations that may be performed to produce the solution may be voluminous, the time for the network to complete a task may be long. Furthermore, because these tasks may be performed on mobile devices, which may have limited computational power, the computational costs of deep neural networks may be problematic.

Neural network architectures are used in various technologies, such as image recognition, pattern recognition, speech recognition, autonomous driving, and other classification tasks. However, machine learning performance may be lower than reported research results. This may be due to variations in training as well as device hardware and their operating environment characteristics, for example. Detecting test samples drawn sufficiently distant from a training distribution statistically is a fundamental requirement for deploying many real-world machine learning applications.

On-device learning is also difficult. One aim of incremental learning is for the learning model to adapt to new data without forgetting its existing knowledge (training). However, specific user data on-device (e.g., user-dependent) may be small. Additionally, a user device may not have a pre-trained dataset (user-independent) on-device. On the other hand, if the device does include a pre-trained dataset (user-independent) on-device, the prospect of catastrophic forgetting may result in the user being forced to train the model from scratch. Catastrophic forgetting occurs when an artificial neural network forgets previously learned information upon learning new information (e.g., out-of-distribution). Furthermore, a machine learning model may specify training with a large number of samples to produce the desired performance levels.

Aspects of the present disclosure are directed to energy efficient, personalizing of an artificial neural network model on a mobile device based on out of distribution detection. A personalized model may be generated when a data input is out of distribution with a training data set for a generalized neural network model. As such, two separate models may be generated. The first model may be a generalized model that is trained on a data set that is user-independent. The second model is the personalized model which is further trained on data that is user dependent.

In some aspects, computation resources between low and high power area components on a system-on-chip (SoC) are cooperatively shared. For example, resource allocation in a SoC low power area may include unified data sensor fusion, time synchronization, a feature extractor, a user-independent classifier (UID), a user-independent out-of-distribution (UIOOD) detector, a user-dependent classifiers (UDC), and a gating agent. In some aspects, knowledge from a more cumbersome or complex UIC may be distilled offline to produce a distilled UIC (UIC_{distilled}). In some aspects, an offline search may be performed to determine an improved, and in some cases an optimal, UDC and/or UIOOD. Additionally, in some aspects, conditional gating may be applied to enable continuous learning and inference.

Furthermore, cooperative incremental learning may be implemented with small sized user-dependent data or out of distribution (OOD) data. In this way, knowledge gained offline may be quickly transferred and employed online.

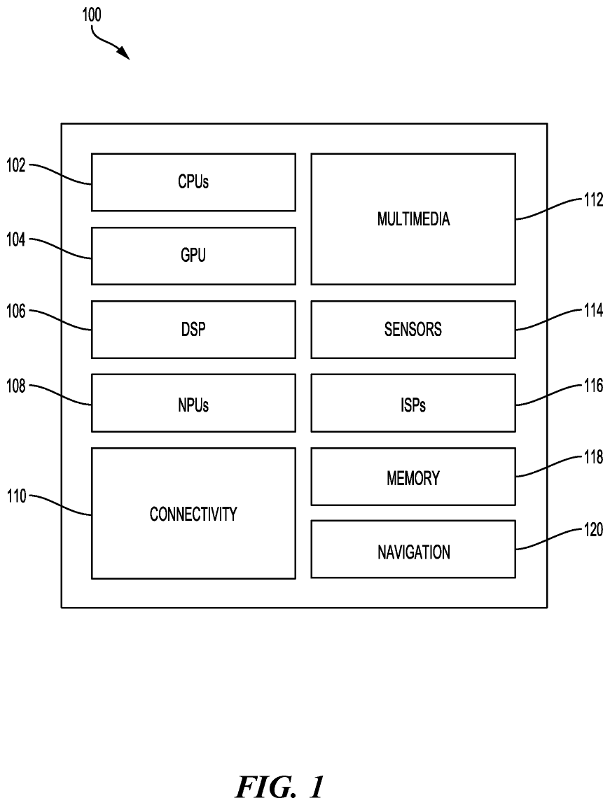

FIG. 1 illustrates an example implementation of a system-on-a-chip (SoC) 100, which may include a central processing unit (CPU) 102 or a multi-core CPU configured for operating an artificial neural network (e.g., a neural end-to-end network). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SoC 100 may also include a sensor processor 114, image signal processors (ISPs) 116, and/or navigation module 120, which may include a global positioning system.

The SoC 100 may be based on an ARM instruction set. In an aspect of the present disclosure, the instructions loaded into the general-purpose processor 102 may include code to receive an input at a first artificial neural network. The general-purpose processor 102 may include code to process the input to extract a set of intermediate features. The general-purpose processor 102 may also include code to determine if the input is out-of-distribution relative to a dataset used to train the first artificial neural network. The general-purpose processor 102 may further include code to provide the intermediate features corresponding to the input to a second artificial neural network based on the out-of-distribution determination.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, then the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

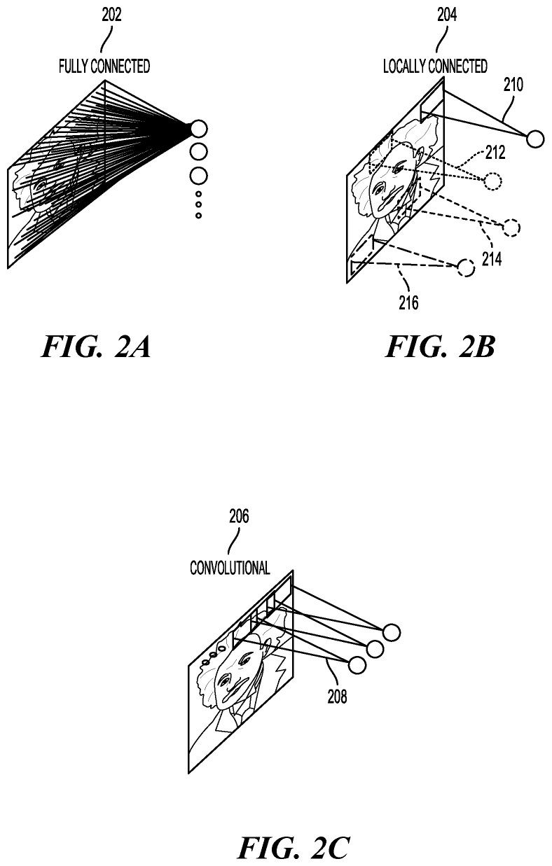

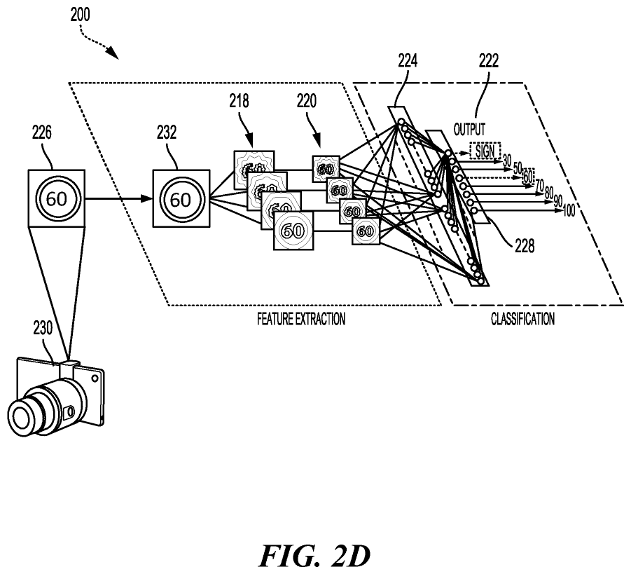

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

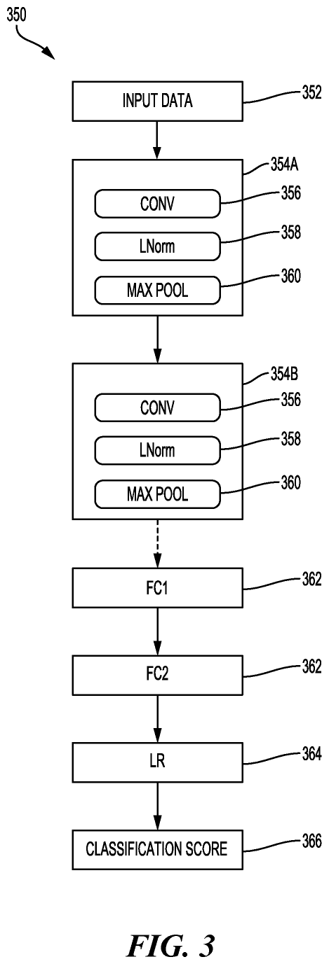

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SoC 100 to achieve high performance and low power consumption. In alternative embodiments, the parallel filter banks may be loaded on the DSP 106 or an ISP 116 of an SoC 100. In addition, the deep convolutional network 350 may access other processing blocks that may be present on the SoC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

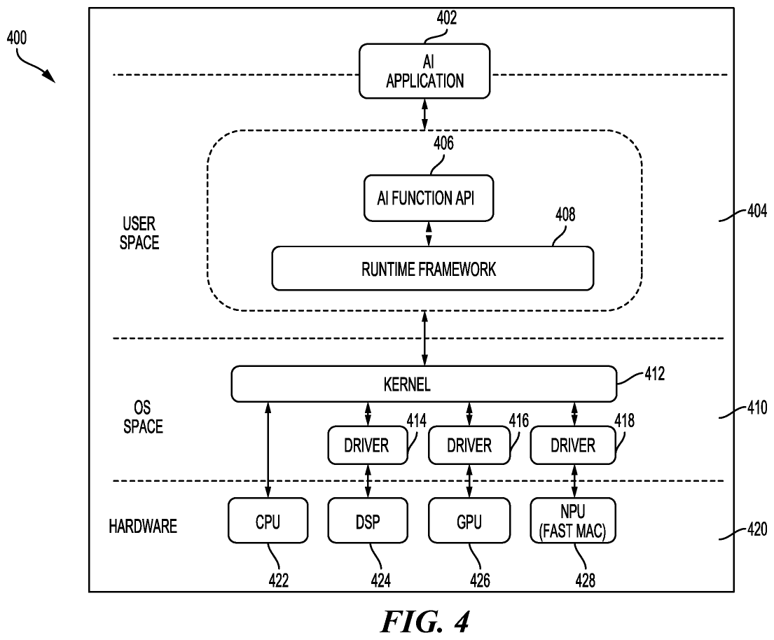

FIG. 4 is a block diagram illustrating an exemplary software architecture 400 that may modularize artificial intelligence (AI) functions. Using the architecture, applications may be designed that may cause various processing blocks of a system-on-a-chip (SoC) 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space, such as a Kernel 412, running on the SoC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Kernel 412, running on the SoC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to energy-efficient on-device out-of-distribution detection and improved classification performance.

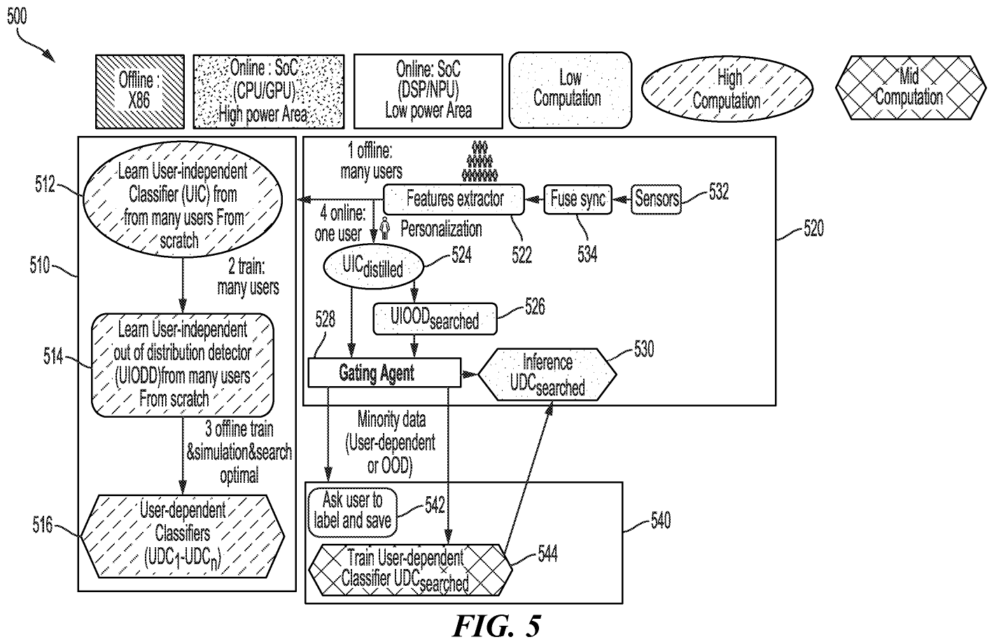

FIG. 5 is a block diagram illustrating an example architecture 500 for energy efficient personalizing of an artificial neural network model, in accordance with aspects of the present disclosure. The example architecture 500 is employed to provide energy-efficient resource allocation to address resource constraints, including power and memory limitations encountered with on-device training. In accordance with aspects of the present disclosure, certain tasks for training and operating an artificial neural network may be assigned to different resources. The example architecture 500 may include one or more resources that may be employed to perform tasks associated with training the neural network or operating the neural network to generate an output (e.g., an inference). The resources may include one or more subsystems such as an offline processor (e.g., an x86 processor), a central processing unit (CPU)/graphics processing unit (GPU), or a digital signal processor (DSP)/neural processing unit (NPU), for instance. Of course, additional or fewer resources may be included according to design preference. In some aspects, the CPU/GPU and DSP/NPU may be provided for online computation, for example on a mobile device such as a smartphone. The CPU/GPU and DSP/NPU may also, in some aspects, be included in a system-on-a-chip (SoC).

Each of the resources may be categorized according to power consumption. For example, the CPU/GPU may be categorized as having high power consumption while the DSP/NPU may be categorized as having lower power consumption. Additionally, various training and inference tasks may be categorized according to computational cost or complexity. For example, a task of leaning a user-independent classifier (e.g., UIC 512) or generalized model may be categorized as a high computation task relative to other training and inference tasks, as it may include processing millions of data samples from a large number of users. On the other hand, feature extraction (e.g., via the feature extractor 522) may be categorized as a low computation task relative to other training and inference tasks. Accordingly, resources may be allocated to perform training and inference tasks associated with generating a personalized model based on power consumption and computational cost or complexity. In some aspects, low computation components/tasks may be executed in a low power area of a system-on-a-chip (SoC). On the other hand, the high computation tasks (e.g., the learning UIC 512, the learning UIOOD detector 514 or the search and optimize UDC 516) may be performed offline via the offline processor 502.

As shown in FIG. 5, an offline process 510 may be performed on an x86. An out-of-distribution detection process 520 may be processed online on, for example, on a low-power elements of a SoC (e.g., DSP or NPU, where lower-power elements may be used for performing less intensive computations). A model personalization process 540 may be processed on a high-power elements of a SoC (e.g., CPU or GPU, where higher-power elements may be used for more intensive computations). Of course, the present disclosure is not so limiting, and such operations of may be performed by any suitable processing element. The offline training process 510 may include tasks such as learning a user-independent classifier (UIC) 512 from many users, learning a user-independent out-of-distribution (UIOOD) detector 514, and offline training and searching to optimize a user-dependent classifier (UDC) 516. An out-of-distribution (OOD) detector process 520 may receive input from a sensor (e.g., camera) 532 that may be processed in a fuse sync 534. The fuse sync 534 receives raw data from the sensor 532 and packages the raw data, which is, in turn, supplied to a feature extractor 522. The extracted features may be provided to a UIC 524.

The UIC 524 may be a distilled version of the UIC (UIC_{distilled}) learned in 512, such that it is a smaller model that may be deployed on a mobile device. The UIC_{distilled} 524 may serve as a majority classifier and a minority data feature extractor. That is the UIC_{distilled} 524 extracts features from the input via successive convolutional layers. Intermediate features extracted from the input may be supplied to a UIOOD 526 and a gating agent 528. The UIOOD detector 526 detects whether the intermediate features are OOD relative to the training data for the UIC 524. If the intermediate features are determined to be in-distribution (e.g., within the majority distribution), then the intermediate features are supplied to the UIC 524, which provides a classification or inference.

On the other hand, if the intermediate features are OOD, data (e.g., within the minority), then the intermediate features are supplied to the gating agent 528 by the UIC 524. The gating agent 528 may be a finite-state machine, for example. The gating agent 528 may provide conditional gating for on-device learning via a personalization module 540 or inference via a UDC 530. If the intermediate features (may be referred to as “minority features”) are represented in training dataset for the UDC 530, then the gating agent may supply the minority features to the UDC 530 to determine an inference. However, if the gating agent determines that minority features or OOD features are not included in the UDC data set, then the gating agent 528 may provide the minority features to the personalization module 540. In some aspects, the user may be prompted to provide a label for such data 542. The label may be used to further train the UDC in block 544.

In some aspects, the architecture may also include a unified fuse-sync-feature extractor pipeline wherein data observed via the sensors 532 may be processed via the fuse sync 534. The features extracted from many users (e.g., recipient of the distributed UIC model) may be collected and supplied for offline training of a more complex UIC 512.

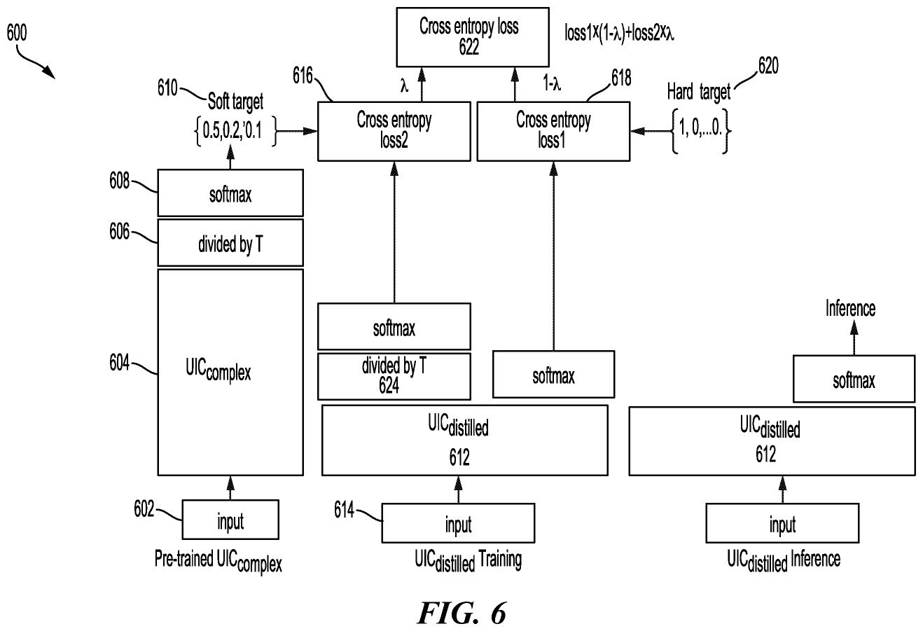

FIG. 6 is a block diagram 600 illustrating offline distilling of knowledge to produce a distilled user-independent classifier (UIC_{distilled}) for operating on a mobile device, in accordance with aspects of the present disclosure. Referring to FIG. 6, a user-independent classifier UIC_{complex} 604 may be trained with hard targets or actual labels (e.g., as performed in task 512 of FIG. 5).

The UIC_{complex} 604 may, for example, be a deep neural network (e.g., deep convolutional network 350) that is trained offline with data from many users. Model compression techniques such as knowledge distilling, for instance, may be applied to UIC_{complex} 604 to transfer knowledge of the UIC_{complex} 604 into a smaller model such as UIC_{distilled} 612. Because UIC_{complex} 604 and UIC_{distilled} 612 may have different network architecture, UIC_{complex} 604 may be used to train UIC_{distilled} 612. Neural networks (e.g., UIC_{distilled} 612) may produce class probabilities by using a “softmax” output layer (e.g., 608) that converts the logit fᵢ(x) computed for each class into a probability pᵢ by comparing fᵢ(x) with the other logits, where T is a temperature. The temperature T is used to scale to logits before applying the softmax function to calibrate the neural network. The temperature T may be set to 1 during inference to recover the original probability. For a given input x at input 614, a softmax score is a maximum softmax probability which is given by:

$${max}_{i} {p}_{i} ( x ; T ) = exp ( {f}_{i} ( x ) / T ) / {\sum }_{j = 1}^{N} exp ( \frac{fj ( x )}{T} ) . \qquad ( 1 )$$

The pre-trained UIC_{complex} 604 may be used to compute soft targets. That is, given an input 602, the UIC_{complex} 604 may operate to compute an output (e.g., an inference). However, the computed output is temperature-scaled (e.g., 606) by dividing the UIC_{complex} 604 output by T, where T is a temperate scaling parameter and T∈R⁺ that is set to a value greater than one (1) during training. Thereafter, a softmax function 608 is applied to the temperature-scaled output. The temperature-scaled outputs are soft targets 610 are then used to train the UIC_{distilled} 612. Using a higher value for T produces a softer probability distribution over all classes. Thus, by using the soft targets 610, computational complexity may be relaxed such that a device having lower computational capability may determine an inference in less processing time than if hard targets were used. That is, the processing speed may be increased with a tradeoff of reduced accuracy. In doing so, the energy efficiency may also be improved as less energy is expended during computation of an inference by UIC_{distilled} 612 trained using the soft targets 610. Conversely, in some aspects greater accuracy may be more important than speed. As such, the UIC_{distilled} 612 may also be trained using the actual labels or hard targets 620. Accordingly, the UIC_{distilled} 612 may be trained using two loss functions (e.g., cross entropy loss 1 and cross entropy loss 2). The cross entropy loss 2 block 616 compute a cross entropy loss (loss 2) based on the soft targets 610. On the other hand, cross entropy loss 1 block 618 computes a cross entropy loss (loss 1) based on hard targets (e.g., actual labels or one-hot vector representations within the original training data) 620. The cross entropy loss 1 and cross entropy loss 2 are supplied to the cross entropy loss block 622 and combined. An importance factor may be applied to loss 1 and loss 2 such that the tradeoff between speed and accuracy may also be considered in training the UIC_{distilled} 612. In this case, the cross entropy loss block 622 may compute the total loss L as:

$$L = ( 1 - λ ) \times loss 1 + λ \times loss 2 , \qquad ( 2 )$$

where λ is an importance rate between cross entropy loss 1 and cross entropy loss 2. In some aspects, the importance rate A may be selected by a user for example based on importance placed on accuracy and speed. In one example, the importance rate A may be set to 0.5 where the importance of speed and accuracy is equal. Accordingly, the UIC_{distilled} 612 may be efficiently trained using the two objective functions (e.g., loss 1 and loss 2.

Having trained the UIC_{distilled} 612, the UIC_{distilled} 612 may be deployed, for example, on a mobile device and used for inference determination (prediction). In some aspects, an intermediate layer activation or its compression (e.g., principal component analysis) from the UIC_{distilled} 612 may be reused as input features for a UIOOD detector or a UDC. That is, UIC_{distilled} 612 is a neural network, for example a CNN with multiple layers, which may be characterized by hierarchical feature extraction. The UIC_{distilled} 612 produces as features, intermediate layer activations (output). The lower layer features may have more data dimension and the higher layers features may have less data dimension. More data dimension may mean more data movement and thus, more computing. From an energy efficiency perspective, different intermediate layer activation of UIC (features) may be selected as inputs for UIOOD/UDC based on an accuracy tradeoff during offline-estimation, for example.

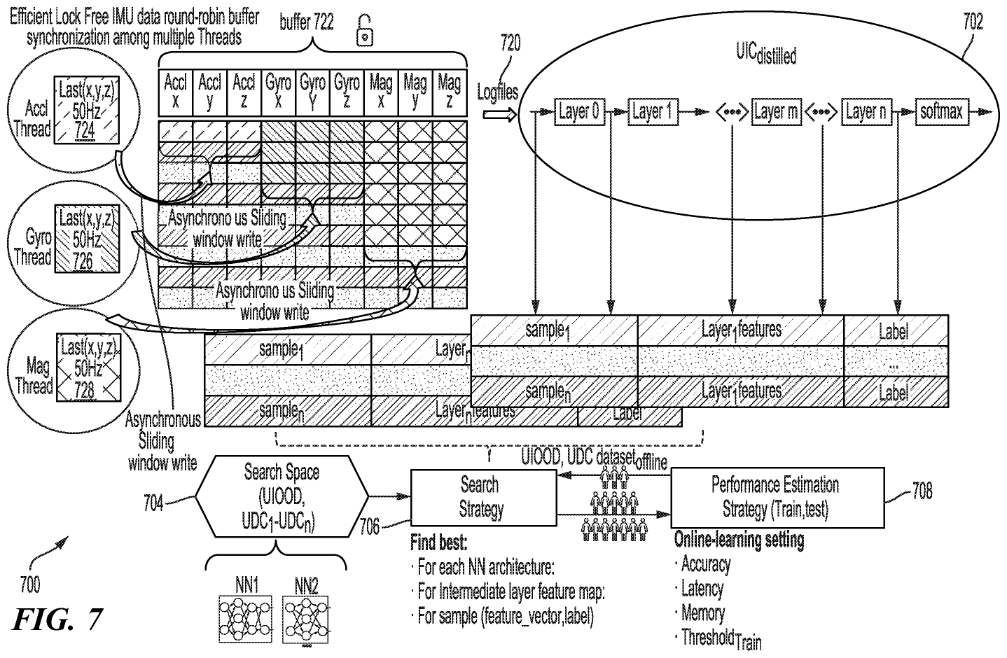

FIG. 7 is a block diagram 700 illustrating an example of offline search and optimization of a user-dependent classifier (UDC) and user-independent out of distribution (UIOOD) detector, in accordance with aspects of the present disclosure. Referring to FIG. 7, an example structure of a distilled user-independent classifier (UIC_{distilled}) 702 is shown. The UIC_{distilled} 702 may receive as input sensor data in the form of log files 720. In one example the log files may include sensor data such as data from an inertial measurement unit (IMU). An IMU may include one or more accelerometers to detect a linear acceleration, one or more gyroscopes to detect a rotational rate, and a magnetometer to detect a heading reference. In the example of FIG. 7, the IMU data may be provided in multiple threads including an accelerometer thread 724, a gyroscope thread 726 and a magnetometer thread 728 and may be stored in a buffer 722. In some aspects, the buffer 722 may be a lock-free (concurrent operations are finished in a finite number of process steps) buffer. The accelerometer thread 724, a gyroscope thread 726 and a magnetometer thread 728 may be supplied to the UIC_{distilled} 702, using round-robin buffer synchronization among the threads, for example.

The UIC_{distilled} 702 includes multiple layers (0-n) followed by a softmax layer, which outputs an inference. In accordance with aspects of the present disclosure, an intermediate layer activation of the UIC_{distilled} 702 or its compression (e.g., principal component analysis) may be used as input features for a UIOOD detector or UDC (not shown). Different layer activations of the UIC_{distilled} 702 may serve as feature inputs to construct UIOOD detector and UDC. Given a search space 704, including UIOOD, UDC₁-UDCₙ, a search strategy 706 may be implemented to identify an improved, and in some aspects optimal, UIOOD and/or UDC architecture (e.g., NN1 and NN2, respectively). In some aspects, an improved and/or optimal intermediate layer feature map or feature vector for a label may be determined.

A performance estimation strategy 708 may assess the performance improvement for each UIOOD and/or UDC architecture. The performance measure or performance estimation strategy 708 may be determined with respect to certain on-line learning metrics. For instance, the performance estimation may be relative to accuracy, latency, memory, or a training threshold. In some aspects, the UDC may be a k-nearest neighbors or neural network (e.g., last or several fully connected layers of a neural network modified to accommodate a class). That is, for shallow learning, a k-nearest neighbors algorithms may be employed. On the other hand, for deep learning, a pre-trained feature extractor (from offline training) may be combined with one full-connection-layer (trainable on device) and several full-connected layers (trainable on device). In one example, performance estimation strategy includes training the UDC with data set for many users and evaluating its performance from individual user data. The offline training for multiple-UIC network architecture may generate many logs files 720. Each of the log files 720 may include, for example, batch size, loss, accuracy and other model details and metrics. Each of the log files 720 may be checked and may inform the performance estimation strategy. In one example, a model with the highest accuracy may be selected as the distilled version of the UIC, UIC_{distilled} 702.

In some aspects, the UIOOD detector (e.g., 526 of FIG. 5) may be configured in various ways to determine whether data is out-of-distribution (OOD). In one approach, extreme value signatures may be used to determine if the data is OOD. Extreme value signatures specify which dimensions of deep neural activations have the largest values. For a known class, the mean vector of activations which may serve as a class prototype may be sorted by value in descending order. Neural activations of test images may also be arranged in order. Using this method the distribution of activation strength follows similar trends as the class prototype. In contrast, images of a novel or different category have strong activations in a different set of dimensions. Accordingly, if data shows a similar extreme value signature as the class prototype, then the data is likely to be in-distribution. On the other hand, if data does not show a similar extreme value signature as the class prototype, then the data is likely to be out-of-distribution.

In a second approach, an input from pre-processing on the softmax score distribution may be used for OOD detection. In the second approach, the softmax score distribution of in- and out-of-distribution examples are closer to 1/N and more separable. In some aspects, OOD detection may be determined by self-supervision. For example, an autoencoder may perform the OOD detection. An autoencoder includes an encoder, which converts the input data into a latent representation (bottleneck layer), and a decoder, which converts the latent representation into outputs (e.g., reconstructed inputs). Because the autoencoder is trained such that the label is the same as the input, it is said to be trained via self-supervision learning.

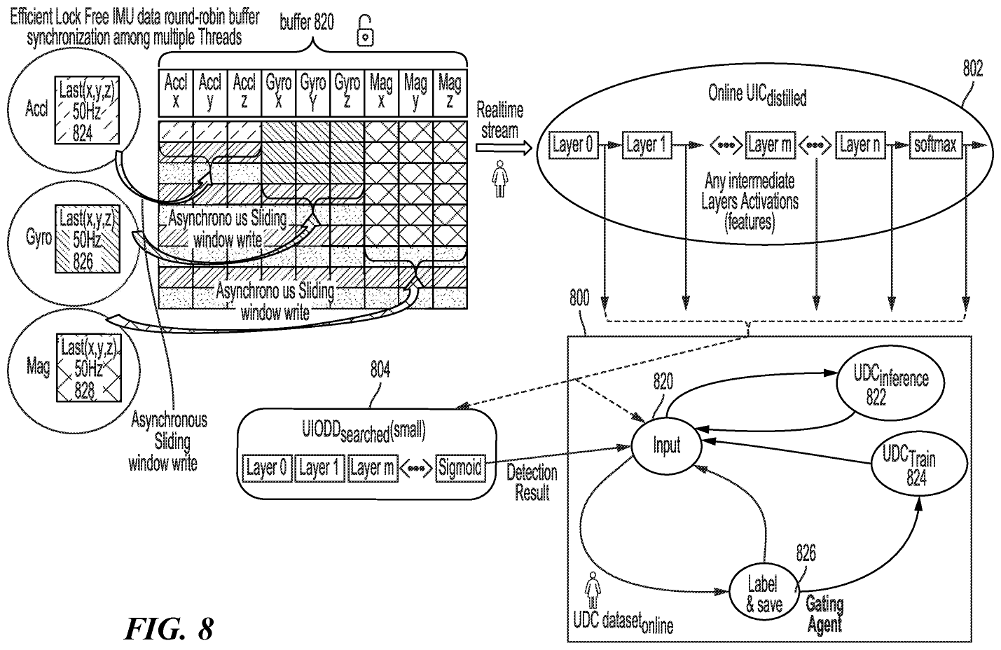

FIG. 8 is a block diagram illustrating an example operation of a gating agent 800, in accordance with aspects of the present disclosure. Referring to FIG. 8, an online distilled user-independent classifier (UIC_{distilled}), and a user-independent out of distribution (UIOOD) detector 804, and gating agent 800 are shown. The gating agent 800 may receive as an input an intermediate later activation from the UIC_{distilled} 802 and an out-of-distribution (OOD) detection determination from the UIOOD detector 804. If the input is determined to be out-of-distribution, then the input or features corresponding to the input may be supplied to the UDC. The UDC may be trained based on the features to produce or update a personalized model. For instance, the input may be evaluated to determine whether the personalized model (e.g., UDC) has been trained on this data input (e.g., a label already exists). If the UDC has already been trained, then the input may be provided to the UDC to determine an inference. On the other hand, if the UDC has not been trained, then the input may be labeled and saved to the UDC dataset. Thereafter, the UDC may be trained and tested.

In some aspects, a synchronization strategy may also be implemented. In one example three sensors (e.g., an accelerator 824, a gyroscope 826, and a magnetometers 828) may supply a real-time stream of input data to UIC_{distilled} 802 via buffer 820. Each sensor may produce an asynchronization style report of (x,y,z) values. Currently systems may be unable to guarantee generation of the sensors data in synchronization, for example, with a fixed frequency (e.g., 50 Hz). In order to synchronize 3 sensors data together, in some aspects, instead of a buffer-locked solution, a more energy-efficient buffer-lock-free solution may be employed. In doing so, buffer 820 may be configured as a 2 dimensional array data structure in memory to save new incoming data from the sensors (e.g., the accelerator 824, the gyroscope 826, and the magnetometer 828). Each column of the buffer 820 may be for one axis of one sensor to write data, and the columns may include data for each sensor, with each sensor having (x,y,z) coordinates. Accordingly, in some implementations, the architecture may be provided and operated without a buffer lock mechanism.

In operation, UIC_{distilled} 802 may receive an input such as image, speech data, or sequence data for example. The input may also be sensor data such as IMU data. In some aspects, the input may be supplied via a real-time data stream. The input may be processed via UIC_{distilled} 802. One or more of the intermediate activations and the output produced by UIC_{distilled} 802 may be supplied to the UIOOD detector 804. The UIOOD 804 may process the activations and output to determine if the input is OOD. The determination may be referred to as a detection result. The detection result may be supplied to gating agent 800 via input 820 along with the intermediate activations and output of the UIC_{distilled} 802. In turn, the gating agent 800 may determine if the OOD data is included in the UDC dataset. If the OOD data is included in the UDC dataset, then the gating agent determines via node 822 that the OOD data is supplied to the UDC (not shown). On the other hand, if the gating agent determines that the OOD data is not included in the UDC dataset, then the gating agent 800 may request or receive a label for the OOD data via node 826. The gating agent 800 may also provide an indication via node 824 to train the UDC based on the OOD data. In some aspects, the UDC may be trained when the number of OOD data received exceeds a predefined threshold.

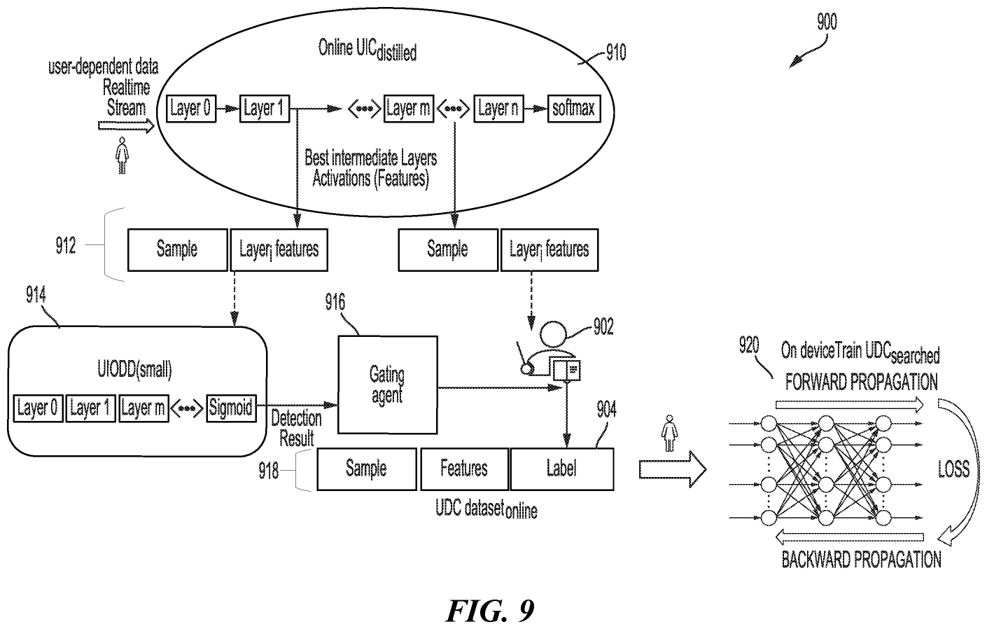

FIG. 9 is a block diagram 900 illustrating an example of cooperative incremental learning on a device, in accordance with aspects of the present disclosure. A user 902 may directly interact to annotate or label 904 online minority data (e.g., user-dependent data or OOD). A UIOOD detector 914 may use intermediate features 912 of a UIC_{distilled} 910 as a feature map for input. Inference results may be written directly reused from a pre-trained model UIC_{distilled} 910 as a UDC dataset 918.

In some aspects, human annotation by a user 902 may also be used to provide labels (e.g., 904) for OOD data. For example, if the UIOOD detector 914 detects the intermediate features or activations are OOD data, then the OOD data may be supplied to gating agent 916. The gating agent 916 may determine whether the UDC dataset 918 includes a label (e.g., 904) for the OOD data. If a label (e.g., 904) is included in the UDC dataset 918, then the UDC 920 may be operated to determine an inference. However, if the UDC dataset 918 does not include a label (e.g., 904) for the OOD data, then the gating agent 916 may prompt the user 902 to provide a label 904.

Using the labeled and saved UDC data set 918, a UDC 920 may be trained from end-to-end rather than by freezing model layers (e.g., intermediate layer activations of the UIC_{distilled}) and modifying the last of several fully connected layers to accommodate a new class. Additionally, a human may also determine when to start on device training with OOD data. Based on this combination of human annotation and end-to-end training, the accuracy of UDC 920 may be improved.

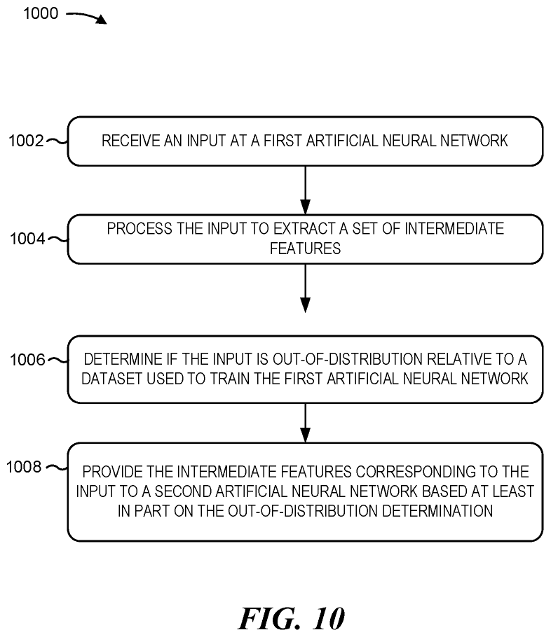

FIG. 10 illustrates a method 1000 for operating an artificial neural network, in accordance with aspects of the present disclosure. As shown in FIG. 10, at block 1002, the method 1000 receives an input at a first artificial neural network. The first artificial neural network may be a user-independent classifier (UIC). Referring to FIG. 6, a UIC (e.g., UIC_{distilled} 612) may be distilled from a more complex artificial neural network (UIC_{complex} 604) that is trained offline based on examples from many users.

At block 1004, the method 1000 processes the input to extract a set of intermediate features. For example, as discussed with respect to FIG. 5, UIC_{distilled} 524 extracts features from the input via successive convolutional layers.

At block 1006, the method 1000 determines if the input is out-of-distribution relative to a dataset used to train the first artificial neural network. As described with reference to FIG. 8, one or more of the intermediate activations and the output produced by UIC_{distilled} 802 may be supplied to the UIOOD detector 804. The UIOOD 804 may process the activations and output to determine if the input is OOD. The determination may be referred to as a detection result.

At block 1008, the method 1000 provides the intermediate features corresponding to the input to a second artificial neural network based at least in part on the out-of-distribution determination. As described with reference to FIG. 8, if the input is determined to be out-of-distribution, then the input or features corresponding to the input may be supplied to the UDC. The UDC may be trained based on the features to produce or update a personalized model.

In some aspects, the resources (e.g., CPU, GPU, NPU, and/or DSP) for performing the training and inference tasks of the first artificial neural network and the second artificial neural network may be allocated according to a computational complexity of the training and inference tasks and a power consumption of the resources.

In one aspect, the receiving means, the determining means, and/or the generating means may be the CPU 102, program memory associated with the CPU 102, the dedicated memory block 118, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

Implementation examples are provided in the following numbered clauses:

1. A method for generating a personalized artificial neural network (ANN) model, comprising:
receiving an input at a first artificial neural network;
processing the input to extract a set of intermediate features;
determining if the input is out-of-distribution relative to a dataset for training the first artificial neural network; and providing the intermediate features corresponding to the input to a second artificial neural network based at least in part on the out-of-distribution determination.

2. The method of clause 1, in which the second artificial neural network is trained on a mobile device based at least in part on the intermediate features.

3. The method of clause 1 in which the second artificial neural network determines a classification based on the intermediate features.

4. The method of clause 1, in which the intermediate features are supplied to a server based at least in part on the out-of-distribution determination.

5. The method of clause 1, in which resources for performing the training and inference tasks of the first artificial neural network and the second artificial neural network are allocated according to a computational complexity of the training and inference tasks and a power consumption of the resources.

6. The method of clause 5, in which the first artificial neural network is a user-independent classifier and the second artificial neural network is a user-dependent classifier.

7. The method of clause 1, further comprising:
determining if the second artificial neural network has been trained based on the out-of-distribution input;
receiving a label for the out-of-distribution input if the second artificial neural network has not been trained based on the out-of-distribution input; and
operating the second artificial neural network to generate an inference, if the second artificial neural network has been trained based on the out-of-distribution input.

8. The method of any of clauses 1-7, further comprising:
comparing an extreme-value signature of the input to a class prototype; and
detecting that the input is out-of-distribution if the extreme-value signature has greater activations in a different set of dimensions than the class prototype.

9. An apparatus for generating a personalized artificial neural network (ANN) model, comprising:
a memory; and
at least one processor coupled to the memory, the at least one processor being configured:
   to receive an input at a first artificial neural network;
   to process the input to extract a set of intermediate features;
   to determine if the input is out-of-distribution relative to a dataset for training the first artificial neural network; and
   to provide the intermediate features corresponding to the input to a second artificial neural network based at least in part on the out-of-distribution determination.

10. The apparatus of clause 9, in which the at least one processor is further configured to train the second artificial neural network on a mobile device based at least in part on the intermediate features.

11. The apparatus of clause 9, in which resources for performing the training and inference tasks of the first artificial neural network and the second artificial neural network are allocated according to a computational complexity of the training and inference tasks and a power consumption of the resources.

12. The apparatus of clause 9, in which the first artificial neural network is a user-independent classifier and the second artificial neural network is a user-dependent classifier.

13. The apparatus of clause 9, in which the at least one processor is further configured:
to determine if the second artificial neural network has been trained based on the out-of-distribution input;
to receive a label for the out-of-distribution input if the second artificial neural network has not been trained based on the out-of-distribution input; and
to operate the second artificial neural network to generate an inference, if the second artificial neural network has been trained based on the out-of-distribution input.

14. The apparatus of any of clauses 9-13, in which the at least one processor is further configured:
to compare an extreme-value signature of the input to a class prototype; and
to detect that the input is out-of-distribution if the extreme-value signature has greater activations in a different set of dimensions than the class prototype.

15. An apparatus for generating a personalized artificial neural network (ANN) model, comprising:
means for receiving an input at a first artificial neural network;
means for processing the input to extract a set of intermediate features;
means for determining if the input is out-of-distribution relative to a dataset for training the first artificial neural network; and
means for providing the intermediate features corresponding to the input to a second artificial neural network based at least in part on the out-of-distribution determination.

16. The apparatus of clause 15, further comprising means for training the second artificial neural network on a mobile device based at least in part on the intermediate features.

17. The apparatus of clause 15, further comprising means for allocating resources for performing the training and inference tasks of the first artificial neural network and the second artificial neural network according to a computational complexity of the training and inference tasks and a power consumption of the resources.

18. The apparatus of clause 17, in which the first artificial neural network is a user-independent classifier and the second artificial neural network is a user-dependent classifier.

19. The apparatus of clause 15, further comprising:
means for determining if the second artificial neural network has been trained based on the out-of-distribution input;
means for receiving a label for the out-of-distribution input if the second artificial neural network has not been trained based on the out-of-distribution input; and
means for operating the second artificial neural network to generate an inference, if the second artificial neural network has been trained based on the out-of-distribution input.

20. The apparatus of any of clauses 15-20, further comprising:
means for comparing an extreme-value signature of the input to a class prototype; and
means for detecting that the input is out-of-distribution if the extreme-value signature has greater activations in a different set of dimensions than the class prototype.

21. A non-transitory computer readable medium having included thereon program code for generating a personalized artificial neural network (ANN) model, the program code being executed by a processor and comprising:
program code to receive an input at a first artificial neural network;
program code to process the input to extract a set of intermediate features;
program code to determine if the input is out-of-distribution relative to a dataset for training the first artificial neural network; and
program code to provide the intermediate features corresponding to the input to a second artificial neural network based at least in part on the out-of-distribution determination.

22. The non-transitory computer readable medium of clause 21, further comprising program code to train the second artificial neural network on a mobile device based at least in part on the intermediate features.

23. The non-transitory computer readable medium of clause 21, further comprising program code to allocate resources for performing the training and inference tasks of the first artificial neural network and the second artificial neural network according to a computational complexity of the training and inference tasks and a power consumption of the resources.

24. The non-transitory computer readable medium of clause 23, in which the first artificial neural network is a user-independent classifier and the second artificial neural network is a user-dependent classifier.

25. The non-transitory computer readable medium of clause 21, further comprising:
program code to determine if the second artificial neural network has been trained based on the out-of-distribution input;
program code to receive a label for the out-of-distribution input if the second artificial neural network has not been trained based on the out-of-distribution input; and
program code to operate the second artificial neural network to generate an inference, if the second artificial neural network has been trained based on the out-of-distribution input.

26. The non-transitory computer readable medium of any of clauses 21-25, further comprising:
program code to compare an extreme-value signature of the input to a class prototype; and
program code to detect that the input is out-of-distribution if the extreme-value signature has greater activations in a different set of dimensions than the class prototype.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for generating a personalized artificial neural network (ANN) model, comprising:
receiving an input at a first artificial neural network;
processing the input to extract a set of intermediate features;
determining if the input is out-of-distribution relative to a dataset for training the first artificial neural network; and
providing the intermediate features corresponding to the input to a second artificial neural network based at least in part on the out-of-distribution determination.

2. The method of claim 1, in which the second artificial neural network is trained on a mobile device based at least in part on the intermediate features.

3. The method of claim 1 in which the second artificial neural network determines a classification based on the intermediate features.

4. The method of claim 1, in which the intermediate features are supplied to a server based at least in part on the out-of-distribution determination.

5. The method of claim 1, in which resources for performing the training and inference tasks of the first artificial neural network and the second artificial neural network are allocated according to a computational complexity of the training and inference tasks and a power consumption of the resources.

6. The method of claim 5, in which the first artificial neural network is a user-independent classifier and the second artificial neural network is a user-dependent classifier.

7. The method of claim 1, further comprising:
determining if the second artificial neural network has been trained based on the out-of-distribution input;
receiving a label for the out-of-distribution input if the second artificial neural network has not been trained based on the out-of-distribution input; and
operating the second artificial neural network to generate an inference, if the second artificial neural network has been trained based on the out-of-distribution input.

8. The method of claim 1, further comprising:
comparing an extreme-value signature of the input to a class prototype; and
detecting that the input is out-of-distribution if the extreme-value signature has greater activations in a different set of dimensions than the class prototype.

9. An apparatus for generating a personalized artificial neural network (ANN) model, comprising:
a memory; and
at least one processor coupled to the memory, the at least one processor being configured:
to receive an input at a first artificial neural network;
to process the input to extract a set of intermediate features;
to determine if the input is out-of-distribution relative to a dataset for training the first artificial neural network; and
to provide the intermediate features corresponding to the input to a second artificial neural network based at least in part on the out-of-distribution determination.

10. The apparatus of claim 9, in which the at least one processor is further configured to train the second artificial neural network on a mobile device based at least in part on the intermediate features.

11. The apparatus of claim 7, in which resources for performing the training and inference tasks of the first artificial neural network and the second artificial neural network are allocated according to a computational complexity of the training and inference tasks and a power consumption of the resources.

12. The apparatus of claim 9, in which the first artificial neural network is a user-independent classifier and the second artificial neural network is a user-dependent classifier.

13. The apparatus of claim 9, in which the at least one processor is further configured:
to determine if the second artificial neural network has been trained based on the out-of-distribution input;
to receive a label for the out-of-distribution input if the second artificial neural network has not been trained based on the out-of-distribution input; and
to operate the second artificial neural network to generate an inference, if the second artificial neural network has been trained based on the out-of-distribution input.

14. The apparatus of claim 9, in which the at least one processor is further configured:
to compare an extreme-value signature of the input to a class prototype; and
to detect that the input is out-of-distribution if the extreme-value signature has greater activations in a different set of dimensions than the class prototype.

15. An apparatus for generating a personalized artificial neural network (ANN) model, comprising:
means for receiving an input at a first artificial neural network;
means for processing the input to extract a set of intermediate features;
means for determining if the input is out-of-distribution relative to a dataset for training the first artificial neural network; and
means for providing the intermediate features corresponding to the input to a second artificial neural network based at least in part on the out-of-distribution determination.

16. The apparatus of claim 15, further comprising means for training the second artificial neural network on a mobile device based at least in part on the intermediate features.

17. The apparatus of claim 15, further comprising means for allocating resources for performing the training and inference tasks of the first artificial neural network and the second artificial neural network according to a computational complexity of the training and inference tasks and a power consumption of the resources.

18. The apparatus of claim 17, in which the first artificial neural network is a user-independent classifier and the second artificial neural network is a user-dependent classifier.

19. The apparatus of claim 15, further comprising:
means for determining if the second artificial neural network has been trained based on the out-of-distribution input;
means for receiving a label for the out-of-distribution input if the second artificial neural network has not been trained based on the out-of-distribution input; and
means for operating the second artificial neural network to generate an inference, if the second artificial neural network has been trained based on the out-of-distribution input.

20. The apparatus of claim 15, further comprising:
means for comparing an extreme-value signature of the input to a class prototype; and
means for detecting that the input is out-of-distribution if the extreme-value signature has greater activations in a different set of dimensions than the class prototype.

21. A non-transitory computer readable medium having included thereon program code for generating a personalized artificial neural network (ANN) model, the program code being executed by a processor and comprising:
program code to receive an input at a first artificial neural network;
program code to process the input to extract a set of intermediate features;
program code to determine if the input is out-of-distribution relative to a dataset for training the first artificial neural network; and
program code to provide the intermediate features corresponding to the input to a second artificial neural network based at least in part on the out-of-distribution determination.

22. The non-transitory computer readable medium of claim 21, further comprising program code to train the second artificial neural network on a mobile device based at least in part on the intermediate features.

23. The non-transitory computer readable medium of claim 21, further comprising program code to allocate resources for performing the training and inference tasks of the first artificial neural network and the second artificial neural network according to a computational complexity of the training and inference tasks and a power consumption of the resources.

24. The non-transitory computer readable medium of claim 23, in which the first artificial neural network is a user-independent classifier and the second artificial neural network is a user-dependent classifier.

25. The non-transitory computer readable medium of claim 21, further comprising:
program code to determine if the second artificial neural network has been trained based on the out-of-distribution input;
program code to receive a label for the out-of-distribution input if the second artificial neural network has not been trained based on the out-of-distribution input; and
program code to operate the second artificial neural network to generate an inference, if the second artificial neural network has been trained based on the out-of-distribution input.

26. The non-transitory computer readable medium of claim 21, further comprising:
program code to compare an extreme-value signature of the input to a class prototype; and
program code to detect that the input is out-of-distribution if the extreme-value signature has greater activations in a different set of dimensions than the class prototype.
